(19) United States
(12) Patent Application Publication
(10) Pub. No.: US 2017/0219191 A1
(43) Pub. Date: Aug. 3, 2017

(54) Clip light device for fitted mountings

(71) Applicants: Donna Marie Fitzgerald, Brookline, MA (US); Michael John Durickas, Newton, MA (US)

(72) Inventors: Donna Marie Fitzgerald, Brookline, MA (US); Michael John Durickas, Newton, MA (US)

(21) Appl. No.: 15/010,483

(22) Filed: Jan. 29, 2016

(51) Int. Cl. F21V 21/088; B62B 9/00; F21V 33/00; A01K 27/00; F21V 23/02; F21V 23/04

(52) U.S. Cl. CPC F21V 21/0885; F21V 23/023; F21V 23/0414; F21V 33/0008; A01K 27/006; B62B 9/005; F21Y 2115/10

(57) ABSTRACT

A clip light device and mounting which provide the means and method for securing the device to a mountings manufactured to accommodate the clip easily, quickly, comfortably, securely, and in an aesthetically pleasing manner. The invention overcomes the limitations of existing battery powered clip light devices and headlamps by utilizing advanced rechargeable batteries, strong micro Light Emitting Diodes (micro-LED) lights, easy recharging via pinout, and novel method attaching the device.

### FIELD OF THE INVENTION

This invention relates to lighting devices, especially to clip light devices which attach to fitted mountings that are manufactured to accommodate the clip.

### RELATED ART

Lights used in combination with clips have existed for many years. These clip light devices vary in quality but generally include a light bulb and battery power source that are built into a housing. The clip component tends to be either built into this housing, as seen in U.S. Pat. Nos. 5,541,816 and 3,032,647, or at the end of an elongated extension as seen in U.S. Pat. Nos. 5,154,483 and D529651 S1.

These clip light devices are often designed with a specific situational use in mind, for instance, the clip light device seen in U.S. Pat. No. D529651 S1 is principally intended for reading and meant for attachment to book covers. There also tends to be an intended surface for the clip light device to attach which is separate from the invention, for example, the clip light devices seen in U.S. Pat. Nos. 5,541,816 and 3,032,647 are both meant to be affixed to the brim of a hat. The clip light device in U.S. Pat. No. D362079 is built to be attached to a broader range of surfaces, but principally for safety purposes. However, as these clip light devices are not designed for attachment to fitted mountings that are manufactured specifically for this purpose, they can look awkward, attach insecurely, bear movement with the affixed object poorly and be dangerous in certain contexts. For instance, if such a clip light device is attached to a jogger's headband, it will attach less securely than it would to a mountings manufactured specifically for this purpose. The more secure the attachment is the safer it is, this particularly true when the clip light device is being used at night for safety and visibility reasons.

With reference to the use of light devices worn by joggers and others in outdoor settings for visibility and safety, such as hikers, there do exist a number of devices which that can assist, such as in U.S. Pat. Nos. 8,066,396 and D553277 S1 which are worn on the head. However, these devices to not include simple clips. Rather they are relatively large and bulky devices, commonly referred to as headlamps that require large battery sources to accommodate intense and extended use. As such, the light device itself is often separated from the battery by a cord. Surgical headlamps, such as U.S. Pat. No. 6,955,444 are likewise bulky and limited in their application to a single fixed mounting. These headlamps are often highly functional but lack the aesthetic possibility and comfort that would be afforded by a smaller and lighter light device that can easily be attached and detached. A smaller and simpler clip light device capable of attachment to fitted mountings manufactured into everyday items such as headbands, hats, armbands, and baby carriages would address these limitations. Such application to a range of fitted mountings offer the user more aesthetic options, as the clip light device can be separated and switched to a different mounting. This interchangeability is also more functionally hygienic when attached to fitted mountings in items of apparel, such as headbands. The user can quickly and easily move the clip light device from a used headband to one freshly laundered.

Battery sources vary between light devices, be they clip light devices or headlamps, but they are usually designed take one to four AA or AAA batteries. Most of such batteries are alkaline based, but the user can always substitute this with rechargeable AA or AAA batteries. Built-in rechargeable batteries do exist in some models but have relatively poor luminosity, limited duration or are strong but impractically large. There is presently no light device which can be clipped to a headband with a battery source capable of granting two plus hours of strong lighting with a small built-in rechargeable battery, a breakthrough modern rechargeable lithium-ion batteries, such as those in smartphones have made possible.

Accordingly, the need remains for a small clip light device which can easily attach and detach to fitted mountings that are manufactured to accommodate the clip in a comfortably, aesthetically pleasing, and secure manner. Therefore it is to this provision that the present invention is primarily directed.

### SUMMARY OF THE INVENTION

The present invention is a clip light device which attaches to fitted mountings that are manufactured to accommodate the clip easily, comfortably, securely, and in an aesthetically pleasing manner. In accordance with the present invention, there is provided a lighting device that overcomes the problems of existing battery powered clip light devices and headlamps. The housing of the clip light device contains a Printed Circuit Board (PCB) populated with micro Light Emitting Diode (micro-LED) lights, six lights in the ideal form, which is powered by a rechargeable battery, a lithium-ion battery in the ideal form, that is recharged through a pinout, a mini Universal Serial Bus mini pinout (mini USB pinout) in ideal form, PCB or plate mounted switch for toggling power and settings, one in ideal form, with physical dimensions for the housing of roughly 5 cm by 6 cm by 1.4 cm in ideal form, with raised corrugation on the rear of the housing to allow for secure attachment to the mounting, and complementary corrugation on the clips inner-side facing the rear of the housing in ideal form. The mounting that is manufactured to receive the clip component of the clip light device is comprised of a slot or pocket that the clip fits securely into. This slot or pocket of the mounting is manufactured into the exterior surface of item of apparel or other surface such that when the clip light device is attached and activated, light emitted projects forward and away from the mounting.

Therefore, it is an object of the invention to provide a micro-LED clip light device which attaches to fitted mountings that are manufactured to accommodate the clip, which provides a comfortable, secure, hygienic and aesthetically pleasing source of illumination for those moving outdoors in limited light.

It is also an object of the invention to provide a micro-LED clip light device which attaches to fitted mountings that are manufactured to accommodate the clip, which is powered by a rechargeable lithium-ion battery in the ideal form.

It is an additional object of invention to provide a micro-LED clip light device which attaches to fitted mountings that are manufactured to accommodate the clip, which has a switch for turning the device on and off.

It is a further object of the invention to provide a micro-LED clip light device which attaches to fitted mountings that are manufactured to accommodate the clip, which has a switch for adjusting the intensity of the light.

It is a further object of the invention to provide a micro-LED clip light device which attaches to fitted mountings that are manufactured to accommodate the clip, which recharges through a mini USB pinout in ideal form.

It is another object of the invention to provide a micro-LED clip light device which attaches to fitted mountings that are manufactured to accommodate the clip, which projects light output away from the user.

it is another object of the invention to provide a method for attaching a micro LED clip light device to fitted mountings that are manufactured to accommodate the clip.

### BRIEF DESCRIPTION OF THE DRAWINGS

FIG. 1 illustrates a top perspective exploded view of a clip light device and mounting in accordance with an embodiment of the invention.

FIG. 2 illustrates a bottom perspective exploded view of a clip light device and mounting in accordance with an embodiment of the invention, represented from a bottom perspective view.

FIG. 3 illustrates top and bottom perspective views of an assembled clip light device and a top perspective view of the mounting in accordance with an embodiment of the invention, represented from a top perspective view.

FIG. 4 illustrates top and bottom perspective views of a front housing of a clip light device in accordance with an embodiment of the invention.

FIG. 5 illustrates top and bottom perspective views of an inner light cover of a clip light device in accordance with an embodiment of the invention.

FIG. 6 illustrates top and bottom perspective views of a power switch of a clip light device in accordance with an embodiment of the invention.

FIG. 7 illustrates top and bottom perspective views of a circuit board of a clip light device in accordance with an embodiment of the invention.

FIG. 8 illustrates top and bottom perspective views of a battery pack of a clip light device in accordance with an embodiment of the invention.

FIG. 9 illustrates top and bottom perspective views of a back housing of a clip light device in accordance with an embodiment of the invention.

FIG. 10 illustrates top and bottom perspective views of a clip of a clip light device in accordance with an embodiment of the invention.

FIG. 11 illustrates top and bottom perspective views of a USB cover, short screw, medium screw, and large screw of a clip light device in accordance with an embodiment of the invention.

FIG. 12 illustrates top and bottom perspective views of the mounting in accordance with an embodiment of the invention.

FIG. 13 illustrates front and aide views of an assembled clip light device affixed to a mounting on a headband in accordance with an embodiment of the invention.

FIG. 14 illustrates front and side views of an assembled clip light device affixed to a mounting on a pet's harness in accordance with an embodiment of the invention.

FIG. 15 illustrates front and side views of an assembled clip light device affixed to a mounting on a child's coat in accordance with an embodiment of the invention.

FIG. 16 illustrates a side view of an assembled clip light device affixed to a mounting on a baby carriage in accordance with an embodiment of the invention. It also illustrates a side view of mounting for a clip light device to affix on a baby carriage in accordance with an embodiment of the invention.

Embodiments of the present invention and their advantages are best understood by referring to the detailed description that follows. It should be appreciated that the same reference numbers are used to identify elements illustrated in one or more of the figures.

### DETAILED DESCRIPTION

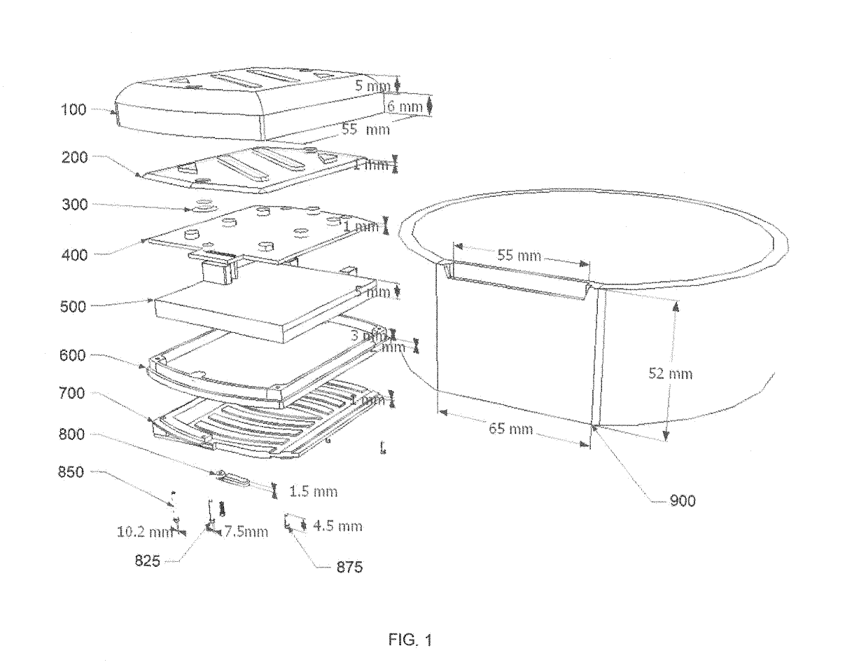

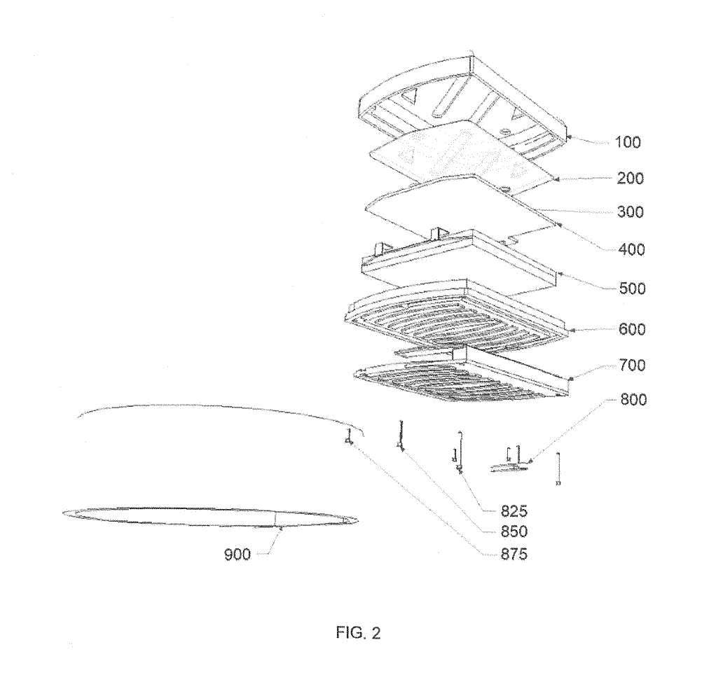

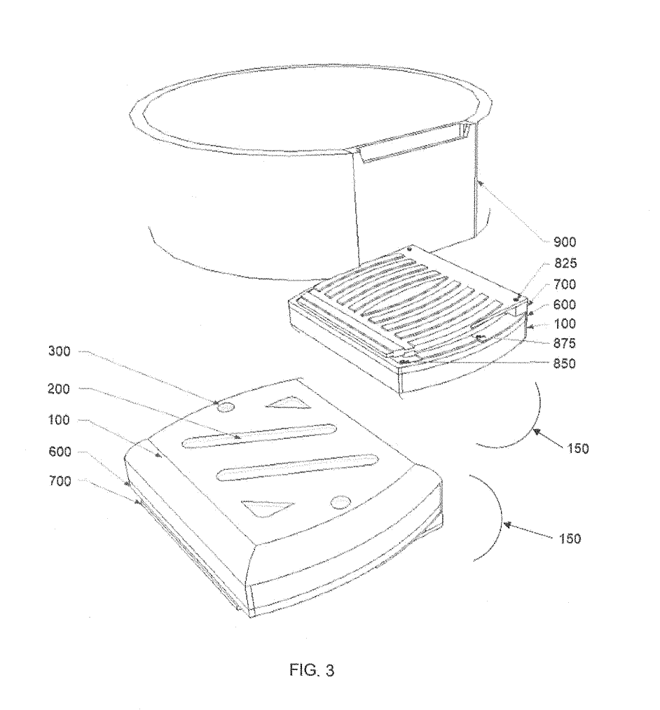

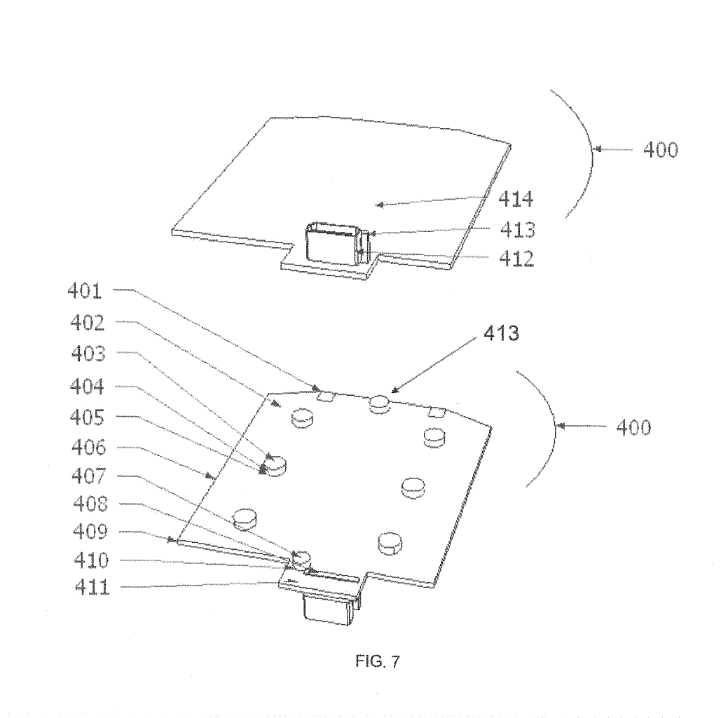

Referring to FIGS. 1 and 2, there is shown an embodiment of the clip light device 150 (FIG. 3) and mounting 900 in accordance with the present invention. This embodiment is comprising of a front housing 100, inner light cover 200, power switch 300, circuit board 400, battery pack 500, back housing 600, clip 700, USB cover 800. long screws 825, medium screws 850, short screws 875, and mounting 900. The front housing 100 has holes to accommodate and fit securely the inner light cover 200 which allows projected light to pass through. The inner light cover 200 also contains a hole allowing the power switch button 300 to pass through to a hole in the front housing 100 for activation. Beneath the inner light cover 200 and power switch button 300 is the circuit board 400 which is populated by items identified in FIG. 7. Beneath the circuit board 400 the battery 500 rests inside the back housing 800. The back housing's 600 top edges are pulled in slightly to slide into the front housing 100 and secure aforementioned parts. The clip 700 fits within a slight depression in the back housing 600. The front housing 100, the back housing 600 and the clip 700 are held in place with 2 long screws 825 in the top corners and short screws 875 do so in the middle on either side. The front housing 100 and back housing 600 have two additional medium screws 850 without passing through the clip 700 which is attached higher on the back housing 600. Additionally, there is a third short screw 875 that holds a USB cover 800 in place within a hole in the back housing to allow access to the mini USB pinout. There is also shown in this embodiment of the present invention a mounting 900 for accepting the clip 700. In the present invention, the mounting 900 has been manufactured into a headband.

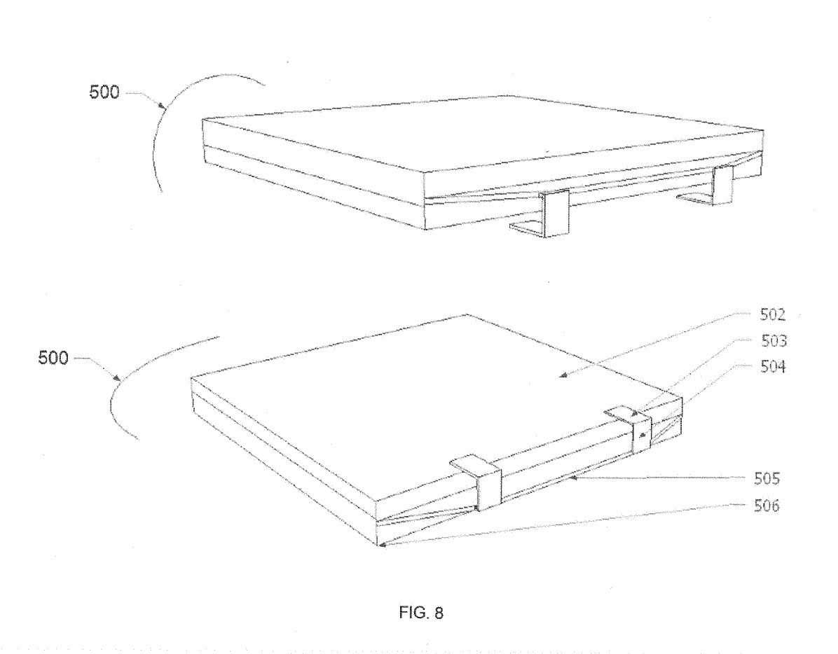

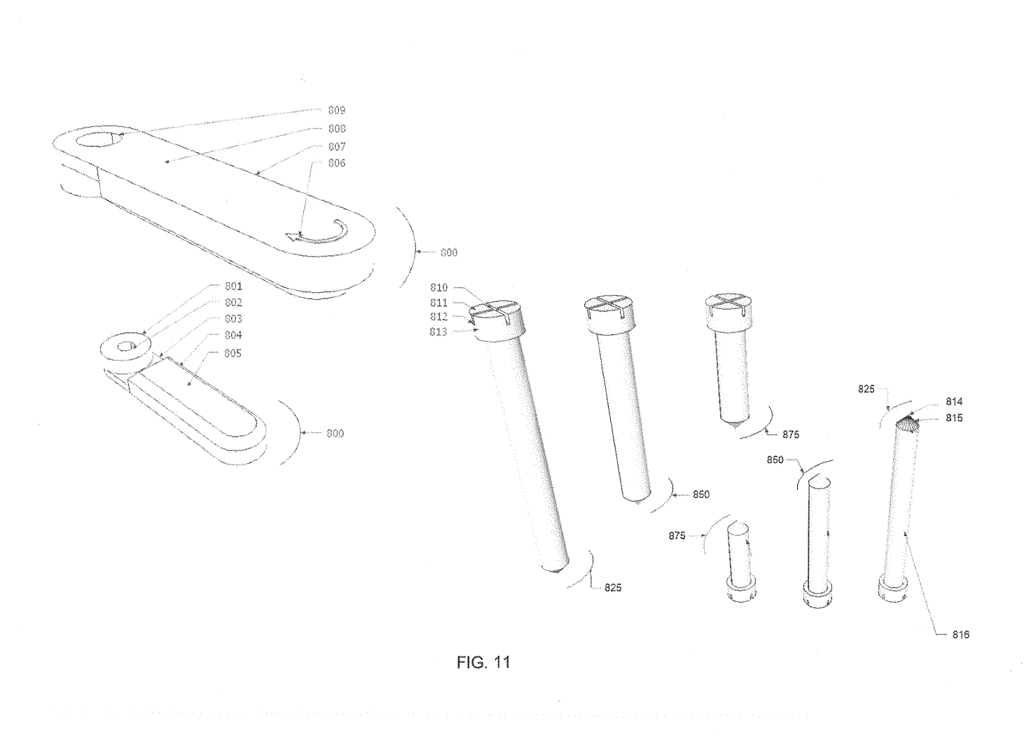

Referring now to FIG. 3, there is shown top and bottom perspective views of an assembled embodiment of the clip light device 150 and a top perspective view of the mounting 900 in accordance with an embodiment of the invention. As previously described in FIGS. 1 and 2, clip light device 150 includes a front housing 100, inner light cover 200, power switch button 300, back housing 600, clip 700, and USB cover 800. The circuit board 400 (FIG. 7), battery pack 500 (FIG. 8), long screws 825 (FIG. 11), medium screws 850 (FIG. 11), and short screws 875 (FIG. 11) are not visible in this assembled view but are included in the assembled device. In this view the clip 700 is attached to the fully assembled clip light device 150 with long screws 825 (FIG. 11) and in this form can slide into the mounting 900. This joining of the clip fight device 150 and the mounting 900 displays a method of attachment not seen in prior art.

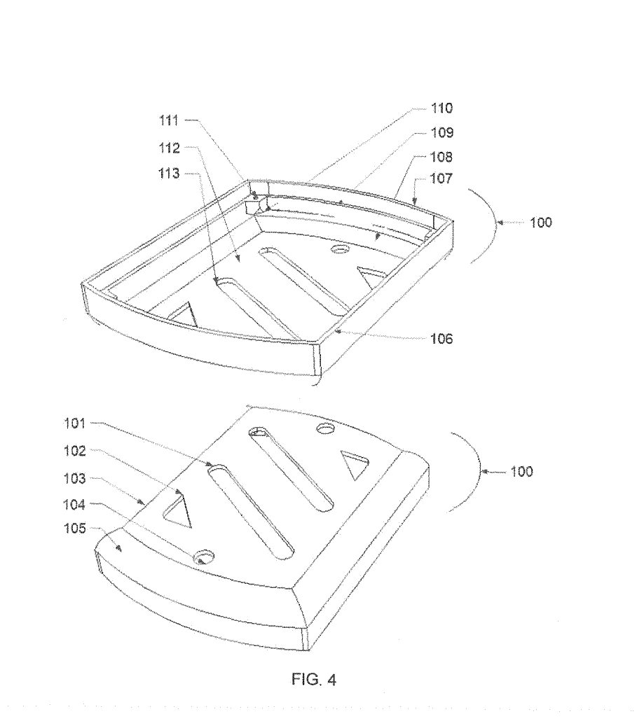

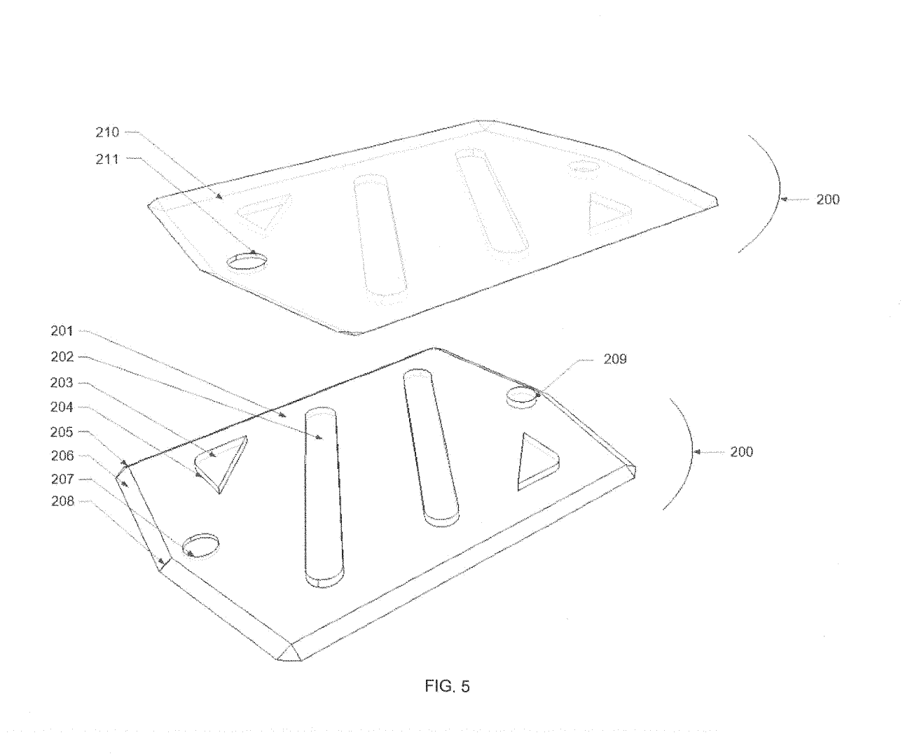

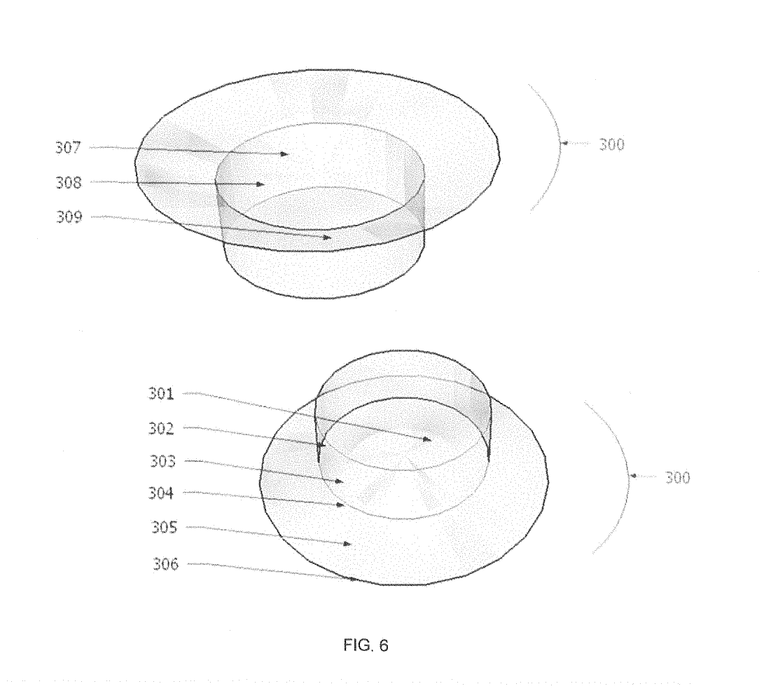

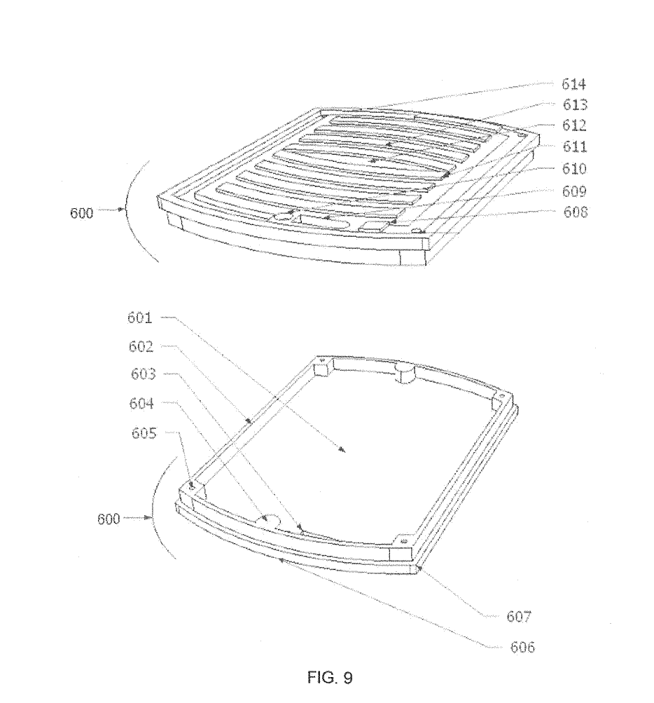

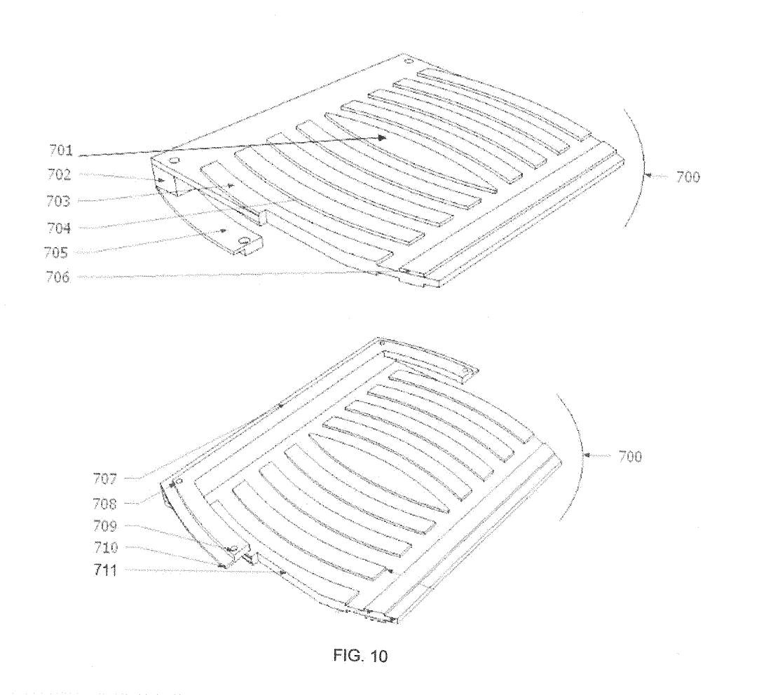

Referring now to FIG. 4, there is shown top and bottom perspective views of a front housing 100 for clip light device 150 (FIG. 3) in accordance with an embodiment of the invention. As previously described in FIGS. 1 and 2, front housing 100 has holes to accommodate and fit securely the inner light cover 200 (FIG. 5) which allows projected light to pass through, and also to accommodate and fit securely the placement of buttons. There are two oval light holes 101 and two triangular light holes 102 in the front housings 100 external face top 103, in this embodiment of the invention, but these may be shaped differently for aesthetic purposes in other embodiments. There are two additional circular holes 104 in the external face top 103 for the power switch button 300 (FIG. 6) and charge indicator 413 (FIG. 7). The far edges of the flat external face top 103 meet the arced external face upper sides 105 before joining to the external face sides 106. The back edge of the external face sides 106 meet the base 107 which is designed to fit against the lower lip 607 (FIG. 9) of the back housing 600 (FIG. 9). An inner-base 109 meets the upper lip 602 (FIG. 9) of the back housing. These bases ring the front housing 100 and at the four corners there are small cubic protrusions 110 for screws to connect the back housing 600 (FIG. 9) and clip 700 (FIG. 10). The internal face upper sides 108 and the internal face 112 allow the internal light cover 200 (FIG. 5) to rest flush against them while the protruding points fit into the oval light holes 101 and triangular light holes 102. Inner hole edges 113 indicate the reverse side of the oval light holes 101.

Referring now to FIG. 5, there is shown top and bottom perspective views of a inner light cover 200 for clip light device 150 (FIG. 3) in accordance with an embodiment of the invention. As previously described in FIGS. 1 and 2, the inner light cover 200 fits securely into the front housing 100 (FIG. 4) and allows projected fight to pass through its holes, while other such holes allow the buttons and indicators to be seen and activated. The light cover top 201 fits flush against the internal face 112 (FIG. 4). The oval light lifts 202 and triangular light lifts 203 are protrusions from the inner light cover 200 which fit snugly in the holes of the front housing 100 (FIG. 4) and create a fiat surface on the external face top 103 (FIG. 4). The lift edges 204 meet intersect with the inner hole edges 113 (FIG. 4) of tie front housing 100 (FIG. 4) just as the light cover top corners 205, light cover sides 206, and light cover end points 208 meet corresponding parts along the internal side of the front housing 100 (FIG. 4). The light cover hole 207 corresponds to the dimensions of the circular holes 104 of the front housing but there is only one which allows the power switch button 300 to pass through (FIG. 6) and be toggled by the user. Where the other circular hole 104 (FIG. 4) in the front housing 100 (FIG. 4) meets the inner light cover 200, there is a single circular light lift 209 which fits as the other light lifts do and allows the charge indicator 413 (FIG. 7) to be seen. The light cover back 210 is completely flat and aside from the light cover hole back 211 which joins with the lower button edge 304 (FIG. 7) of the power switch button 300 (FIG. 7).

Referring now to FIG. 6, there is shown top and bottom perspective views of a power switch button 300 for clip light device 150 (FIG. 3) in accordance with an embodiment of the invention. As previously described in FIGS. 1 and 2, the power switch button 300 passes through to a hole in the front housing 100 (FIG. 4) and inner light cover 200 (FIG. 5 for activation on contact with the PCB mounted switch 407 (FIG. 7) on the circuit board (FIG. 7). When positioned in the assembled light clip device 150, the power switch button top 301 is flush with the external face top 103 (FIG. 4) and the upper button edge 302 meets the upper edges of the circular hole 104 (FIG. 4). As described in FIG. 4. the lower button edge 304 joins with the light cover hole back 211 (FIG. 5) while the button side 303 fits two components noted above. The button ring 305 is arced to allow for give in the flexible material used for the button, while the button lower rim 306 rests on the circuit board face 401 (FIG. 7). There is a domed dip 307 in the power switch button 300 that fits the PCB mounted switch 407 (FIG. 7) while allowing the dip ridge 308 and button base to remain flush on the circuit board face 401 (FIG. 7).

Referring now to FIG. 7, there is shown top and bottom perspective views of a circuit board 400 for clip light device 150 (FIG. 3) in accordance with an embodiment of the invention. Circuit board 400 is positioned in the assembly between, the inner light cover 200 (FIG. 6) and power switch button 300 (FIG. 6) resting above it, and the battery 500 (FIG. 8) directly below it against the board underside 414. The board surface 402 is sized to fit snugly within the housing inner sides at the board edges 406 and board corners 409. Populating the board are power inputs 401, 6 micro-LED lights 404, control circuitry and a potentiometer in embodiments allowing for variation in light intensity. The micro-LED light tops 403 are aligned directly below the holes in the front housing 100 (FIG. 4) and inner light cover 200 (FIG. 5) to allow light to project outward from the user. Around the micro-LED light bases 405 reflectors enhance directed light output forward. The PCB mounted switch 407 sits on the circuit board and directly below the domed dip 307 (FIG. 6) in the power switch button 300 (FIG. 6). The board slit 408 allows for the board extension 413 to be attached for both support and connect the mini USB pinout 412.

Referring now to FIG. 8, there is shown top and bottom perspective views of a battery 500 for clip light device 150 (FIG. 3) in accordance with an embodiment of the invention. As previously described in FIGS. 1 and 2, the battery 500 rests firmly between circuit board 400 (FIG. 7) and the battery top 502 on the upper side, and between the back housing 600 (FIG. 9) and the battery bottom 501. The battery 500 in this embodiment is a lithium-ion battery rechargeable through the mini USB pinout 412 (FIG. 7). Connecting the battery 500 to the circuit board 400 (FIG. 7) is a power ribbon 504 which runs to connections to the board power inputs through power ribbon connections 503. The battery edges 505 and battery corners 506 are designed to fit fixed within the back housing 600 (FIG. 9).

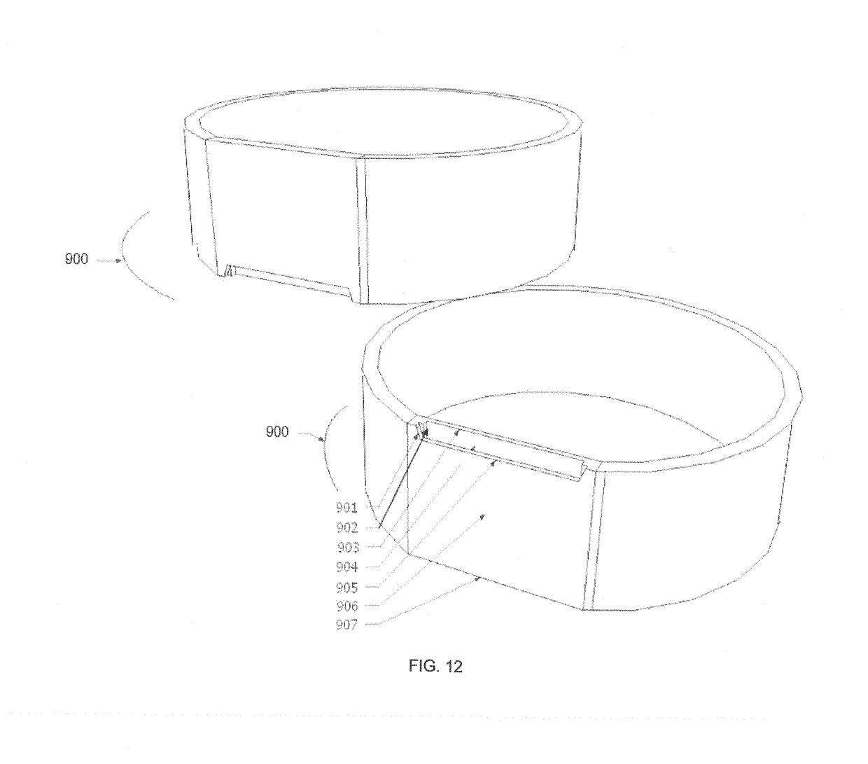

Referring now to FIG. 9, there is shown top and bottom perspective views of a back housing 600 for clip light device 150 (FIG. 3) in accordance with an embodiment of the invention. As previously described in FIGS. 1, 2 and 4, the back housing's 600 upper lip 602 is pulled in slightly to slide into the front housing 100 (FIG. 3) and enclose the battery 500 (FIG. 8) at rest directly above the back housing floor 601. The lower lip 607 completes this closure with the front housing 100 (FIG. 4) at the inner-base 109 (FIG. 4). There is one hole in the back housing floor 601 to allow the mini USB pinout 412 through, though a USB cover 800 (FIG. 11) seals this USB hole 603 on the reverse side when not in use at external USB hole 609. The USB cover is designed to lift up and swivel in this embodiment, held in place with a short screw 875 (FIG. 11) that feeds through a back cover screw hole 610 and cover mid cavity 604 with internal threading for receiving the screw. There is a second cover mid cavity 604 on the reverse side. Cover corner cavities 605 are positioned at each corner of the back cover with corresponding back cover screw holes 610, only without the threading, as the screws are received by the threaded screw holes of the front housing 100 (FIG. 400). There is a slight clip depression 614 in the back housing 600 to receive the clip 700 (FIG. 10) and three of the screws noted above pass through the clip 700 (FIG. 10) and into back housing 600 to secure this component in place. The back edges 606 are rounded slightly to prevent injury to the user. The external side of the back housing has a raised corrugation for dripping the mounting 900 (FIG. 12) securely and includes sight depressions 612 and arced lifts 613 which meet at the lift center 611 while the clip 700 (FIG. 10) has a complementary corrugation. Below this corrugation the there is a flat area 608 to make attachment to mountings 900 (FIG. 12) easier.

Referring now to FIG. 10, there is shown top and bottom perspective views of a clip 700 for clip light device 150 (FIG. 3) in accordance with an embodiment of the invention. As previously described in FIGS. 1, 2 and 9, the clip 700 fits into the back housing 600 (FIG. 9) and is held in place with 2 long screws 825 (FIG. 11) in the top comers holes 708 and short screws 875 (FIG. 11) in the middle holes 709. The clip base 705 fits into the back housing's 100 clip depression 614 (FIG. 9) along a locking depression of two depths, the clip low joining point 707 and a clip high joining point 710. In a manner corresponding to the external side of the back housing, both sides of clip have raised corrugation for gripping the mounting 900 (FIG. 12), with slight depressions 704, arced lifts 703, central lifts 701 and bar base lifts 706. There is a clip indention 711 made to allow easy for the user to the USB pinout.

Referring now to FIG. 11, there is shown the USB cover 800, short screw 875, medium screw 850 and large screw 826 of a clip light device in accordance with an embodiment of the invention, represented from a perspective view. As previously described in FIGS. 1, 2 and 10, the USB cover 800 fits into the back housing 600 (FIG. 9) and is secured by a short screw 875. The cover swivel 801 fits into the cover screw hole 610 (FIG. 10) of the back housing 600 (FIG. 10) and may be turned right and left while the screw is stationary having passed through the USB cover hole 802 and secured to the threading of the cover mid cavity 604 (FIG. 10). The screw head 813 fits into the top USB hole 809 to secure. This component is made of a more flexible material allowing it to bend, especially at the bridging point 803 between the cover swivel 801 and the cover plug 805 which is directly against mini USB pinout 412 (FIG. 7) when at rest. The plug sides 804 are angled at the base to lift more easily and correspondingly angled on the external USB hole 609 (FIG. 9) it fits into. When secured, the USB cover top 808 is level with the arced lifts 613 (FIG. 10) of the back housing 600 (FIG. 9) providing long raised edge 807 for the user to lift and turn the USB cover 800. An instructional symbol 806 helps the user operate the component. FIG. 11 also illustrates a short screw 875, medium screw 850, and large screw 825 which enter the clip light device through the Clip 700 (FIG. 10) and back housing 600 (FIG. 9). Each of the screws are metal with standard Phillips-head screw tops 810, flat heads 811, and groves 812 to turn. Each screw has side threading 816 toward the end to grip the front housing 100 (FIG. 3) thread, and ends in a cone 815 with a point 814.

Referring now to FIG. 12, there is shown top and bottom perspective views of a mounting 900 for clip light device 150 (FIG. 3) in accordance with an embodiment of the invention. As previously described in FIGS. 1, 2 and 10, there is shown a mounting 900 that has been manufactured into a headband to accept the clip 700 (FIG. 10) of the clip light device 150 (FIG. 3). At the top of the mounting 900 there is a clip slit 902 for accepting the clip 700 (FIG. 10). The outward facing top 905 of the clip slip 902, dips slightly to allow the clip 700 (FIG. 10) top to appear level with the inward facing top 903. On the outward face top corners 901 the mounting angles. Both the internal mounting surface 904 and mounting outward face 906 is flat in this model, while other embodiments of the invention have slight corrugation to match that found on the of the mounting corrugation. The lower mounting edge 907 does not open into a slip as above, rather it is closed to create something like a fitted pocket for the clip 700 (FIG. 10) of the clip light device 150.

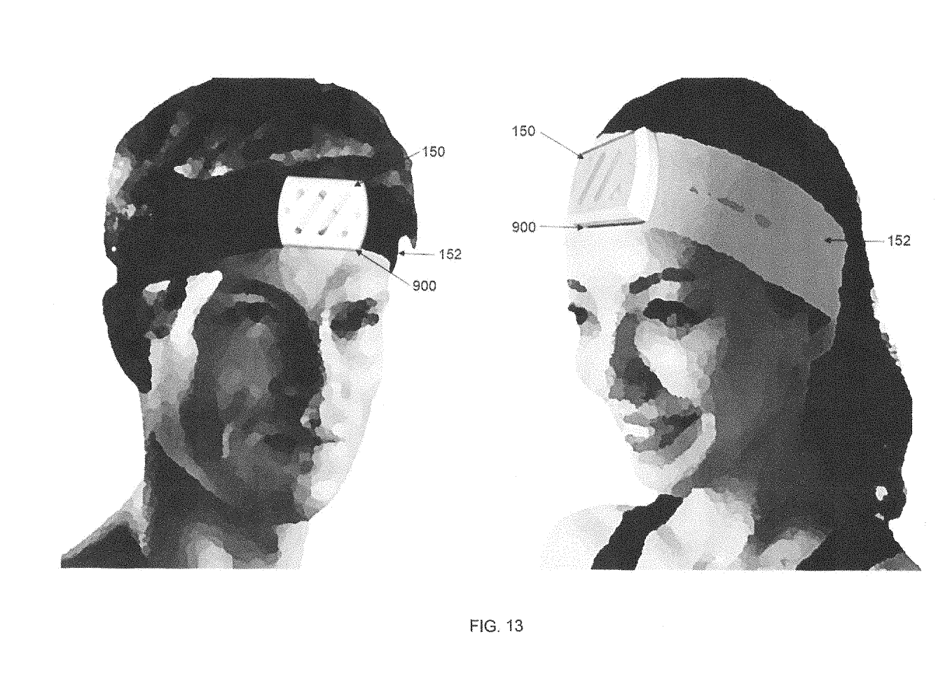

Referring now to FIG. 13, there is shown front and side views of the clip light device 150 attached to the mounting 900 that has been manufactured into the headband 152 and worn by users in accordance with a second embodiment of the invention's mounting surface. As previously described in FIGS. 1, 2, 10 and 12, the clip 700 (FIG. 10) of the clip light device 150 has been placed into the clip slip 903 and attached, allowing the user to project a strong beam of light forward and away from where they are looking.

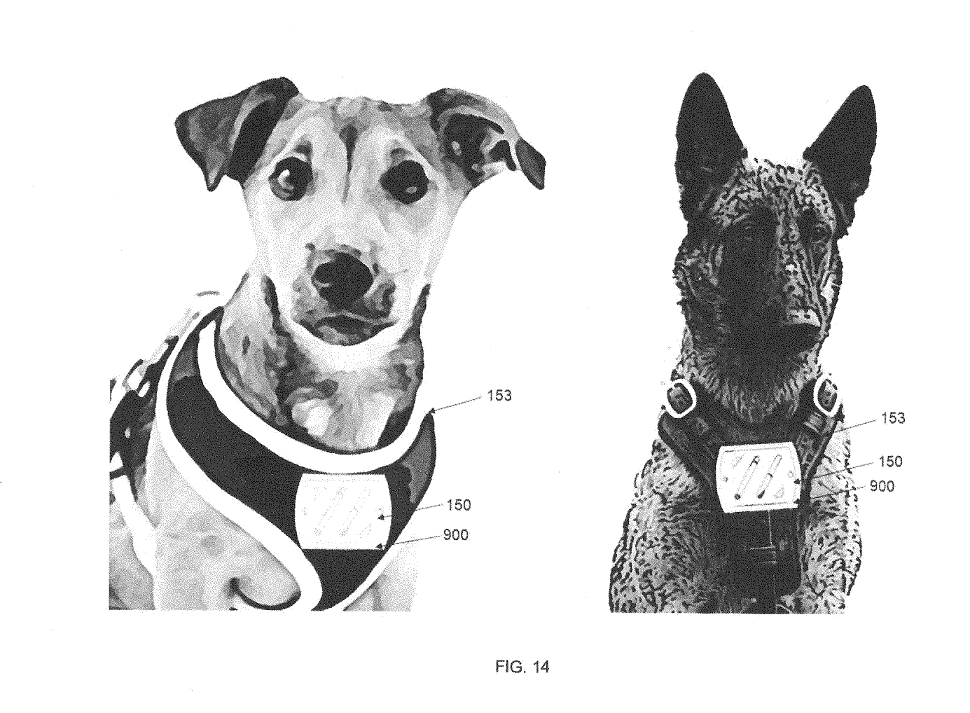

Referring now to FIG. 14, there is shown front and side views of the clip light device 150 attached to the mounting 900 that has been manufactured into a pet harness 153 and worn by users in accordance with a third embodiment of the invention's mounting surface. As previously described in FIG. 13, the clip 700 (FIG. 10) of the clip light device 150 has been place into the clip slip 903 and attached, allowing the user to project a strong beam of light forward and away from where they are looking.

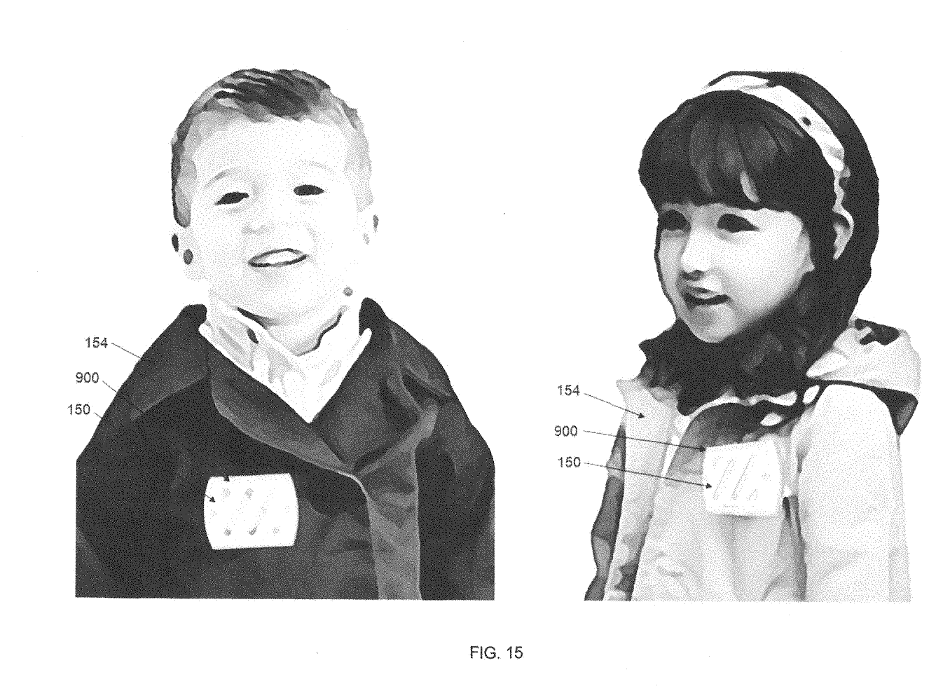

Referring now to FIG. 15, there is shown front and side views of the clip light device 150 attached to the mounting 900 that has been manufactured into a coat 154 and worn by users in accordance with a forth embodiment of the invention's mounting surface. As previously described in FIG. 13, the clip 700 (FIG. 10) of the clip light device 150 has been place into the clip slip 903 and attached, allowing the user to project a strong beam of light forward and away from where they are looking.

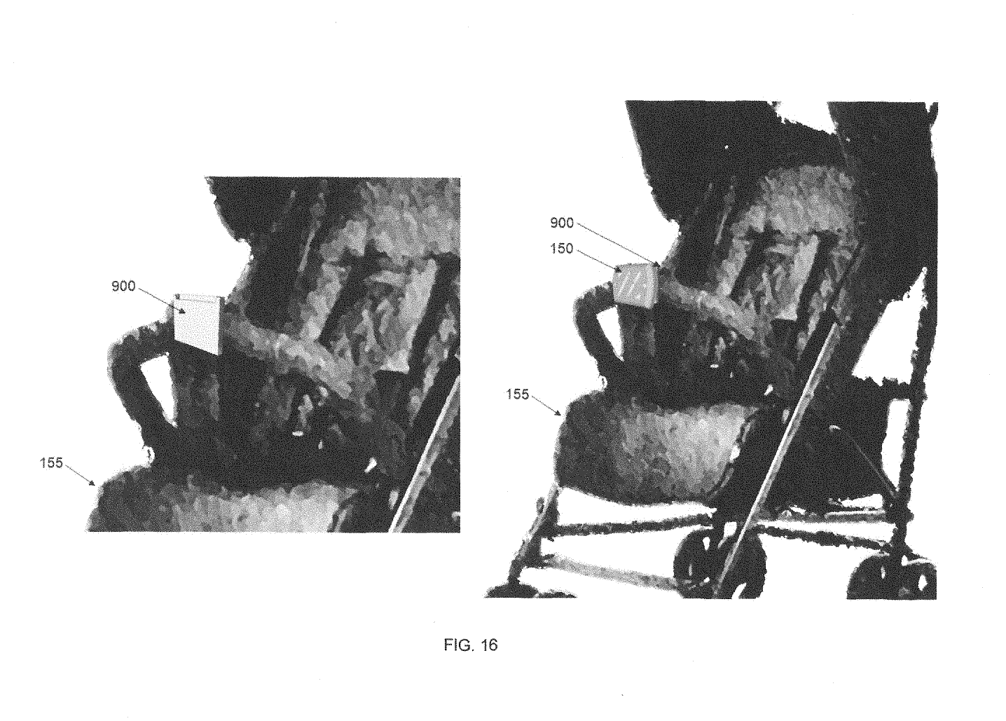

Referring now to FIG. 16, there is shown side views of the clip light device 150 attached to the mounting 900 that has been manufactured into a baby carriage 155 and worn by users in accordance with a second embodiment of the invention's mounting surface. As previously described in FIG. 13, the clip 700 (FIG. 10) of the clip light device 150 has been place into the clip slip 903 and attached, allowing the user to project a strong beam of light forward and away from where they are looking.

The preceding disclosure is not meant to omit the present invention to the precise embodiments described nor their scope of their application. Alternate forms including multiple modifications are permitted in accordance the present invention.

1. A lighting device and mounting comprising:
a clip fight device comprising: a circuit board and circuitry, multiple micro Light Emitting Diode (micro-LED), reflectors, a high performance rechargeable battery, a in out for recharging, a power indicator, a power switch, a user control, a transparent, or translucent inner cover, a housing for aforementioned components comprising of a front housing with windows for lights and back housing with housing raised corrugation for improved grip, a clip with raised corrugation for grip and attachment to mounting; and a mounting comprising: a slot or pocket that accommodates clip and dimensions that snugly accept the clip and back housing surfaces.

2. A method of attaching a clip light device and mounting of claim 1, the method comprising:
attachment of the clip light device to mounting by sliding the clip on the back housing of the clip light device into a slot within the mounting; and
wherein utilizing the clips mechanical energy to secure clip light device firmly; and
wherein raised corrugations on clip light device to further secure clip; and
wherein raised corrugations on the clip increase grip; and

[symbol]

3. A method of attaching a clip light device and mounting of claim 1, the method comprising:
attachment of the clip light device to mounting by sliding the clip on
the back housing of the clip light device into a slot within the mounting; and
wherein utilizing the clips mechanical energy to secure clip light device firmly; and
wherein raised corrugations on clip light device to further secure clip; and
wherein raised corrugations on the clip increase grip; and
wherein the clip light device attaches to a mounting that has been manufactured into articles of apparel, such as, headbands, hats, coats and pet harnesses.

4. A method of attaching a clip light device and mounting of claim 1, the method comprising:
attachment of the clip light device to mounting by sliding the clip on the back housing of the clip light device into a slot within the mounting; and
wherein utilizing the clips mechanical energy to secure clip light device firmly; and
wherein raised corrugations on clip tight device to further secure clip; and
wherein the lighting device attaches to a portable mounting which attaches to surfaces in a semi-permanent fashion, such as on a baby carriage.
